(19) United States
(12) Patent Application Publication
(10) Pub. No.: US 2016/0210338 A1
(43) Pub. Date: Jul. 21, 2016

(54) System for Collaborative Data Analytics for Time Series Data

(71) Applicant: i3D Technologies dba H20Metrics, Ann Arbor, MI (US)

(72) Inventors: Tobin H. Van Pelt, Mill Valley, CA (US); Robert S. Czachorski, Ypsilanti, MI (US); Christopher J. Henn, Mill Valley, CA (US)

(73) Assignee: i3D Technologies, Inc. dba H20Metrics, Ann Arbor, MI (US)

(21) Appl. No.: 14/997,927

(22) Filed: Jan. 18, 2016

Related U.S. Application Data
(60) Provisional application No. 62/105,103, filed on Jan. 19, 2015.

(51) Int. Cl. G06F 17/30; H04L 29/08; G06F 3/0484

(52) U.S. Cl. CPC G06F 17/30554; G06F 17/30477; G06F 17/30312; G06F 3/0484; H04L 67/02

(57) ABSTRACT

A collaborative water analytics is provided. The analytics system may provide information for feeds of time series data associated with water and sewer systems. The data may include sewer flow, rainfall, and other water-related data for municipal systems and other water providers. The time series data may include any measurement, such as for example counts, flow rate, pressure, depth, and so on, sampled from a sensor over a period of time.

### CROSS-REFERENCE TO RELATED APPLICATIONS

This application claims the priority benefit of U.S. provisional application 61/105,103, titled “Cloud Based Collaborative Data Analytics for Time Series Data,” filed Jan. 19, 2015, the disclosure of which is incorporated herein by reference.

### BACKGROUND

Water has been a vital resource to civilizations for hundreds if not thousands of years. With urban areas and rural lands competing for water usage, especially in times of drought, detailed monitoring of water usage and water systems such as sewer systems is an important part of managing water supply.

Sewer flow data and rainfall data have been analyzed for many years. In some cases, there is years of data available to analyze. In addition to this existing data, some systems continually collect additional data to which can be analyzed with respect to the previous data. What is needed is an improved system for collaborating and analyzing time series data.

### SUMMARY

The system of the present technology, roughly described, provides collaborative water analytics. The analytics system may provide information for feeds of time series data associated with water and sewer systems. The data may include sewer flow, rainfall, and other water-related data for municipal systems and other water providers. The time series data may include any measurement, such as for example counts, flow rate, pressure, depth, and so on, sampled from a sensor over a period of time.

Once the data is accessed, the data may be manipulated and provided in a number of ways along with several features. The data may be provided graphically and may be analyzed, annotated, and otherwise processed. One or more data feeds of data may be displayed or hidden, inspected, filtered, edited, annotated, and shared. Metrics may be generated for specific periods and one or more selected data feeds, and may be shared and automatically generated for display to a user. The present system may identify and report patterns for rainfall, sewer flow, and other water activity, and provide the reports through tables, graphics, plots and other formats.

An embodiment includes a method for analyzing data for time-series data retrieved from a water sensor system. A remote server may retrieve time series data collected from a water system. The time series data to be displayed within a content page by a network browser application may be processed. The network browser application may be provided by a client machine remote from the server. A subset of the processed time series data may be provided in multiple graphical representations within the content page. The scale of one or more of the multiple graphical representations may be modified in response to user input.

An embodiment includes a system for analyzing data for time-series data retrieved from a water sensor system. The system may include a server having a memory and a processor. One or more modules may be stored in the memory and executed by the processor to retrieve by a remote server time series data collected from a water system, process the time series data to be displayed within a content page by a network browser application provided by a client machine remote from the server, provide a subset of the processed time series data in multiple graphical representations within the content page, and modify the scale of one or more of the multiple graphical representations in response to user input.

### BRIEF DESCRIPTION OF FIGURES

FIG. 1 is a block diagram for a collaborative water analytics system.

FIG. 2 is a block diagram of an application server.

FIG. 3 is a method for providing collaborative water analytics.

FIG. 4 is a method for reporting data.

FIG. 5 is a method for displaying data through a content page.

FIG. 6 is a method for annotating data.

FIG. 7 is a snapshot of a content page interface for providing metrics.

FIG. 8 is a snapshot of a content page interface for providing annotations.

FIG. 9 is a snapshot of a content page interface for configuring vertical axes.

FIG. 10 is a snapshot of another content page interface for configuring vertical axes.

FIG. 11 is a block diagram of a computing environment for implementing the present technology.

### DETAILED DESCRIPTION

The system of the present technology, roughly described, provides collaborative water analytics. The analytics system may provide information for feeds of time series data associated with water and sewer systems. The data may include sewer flow, rainfall, and other water-related data for municipal systems and other water providers. The time series data may include any measurement, such as for example counts, flow rate, pressure, depth, and so on, sampled from a sensor over a period of time.

Once the data is accessed, the data may be manipulated and provided in a number of ways along with several features. The data may be provided graphically and may be analyzed, annotated, and otherwise processed. One or more data feeds of data may be displayed or hidden, inspected, filtered, edited, annotated, and shared. Metrics may be generated for specific periods and one or more selected data feeds, and may be shared and automatically generated for display to a user. The present system may identify and report patterns for rainfall, sewer flow, and other water activity, and provide the reports through tables, graphics, plots and other formats.

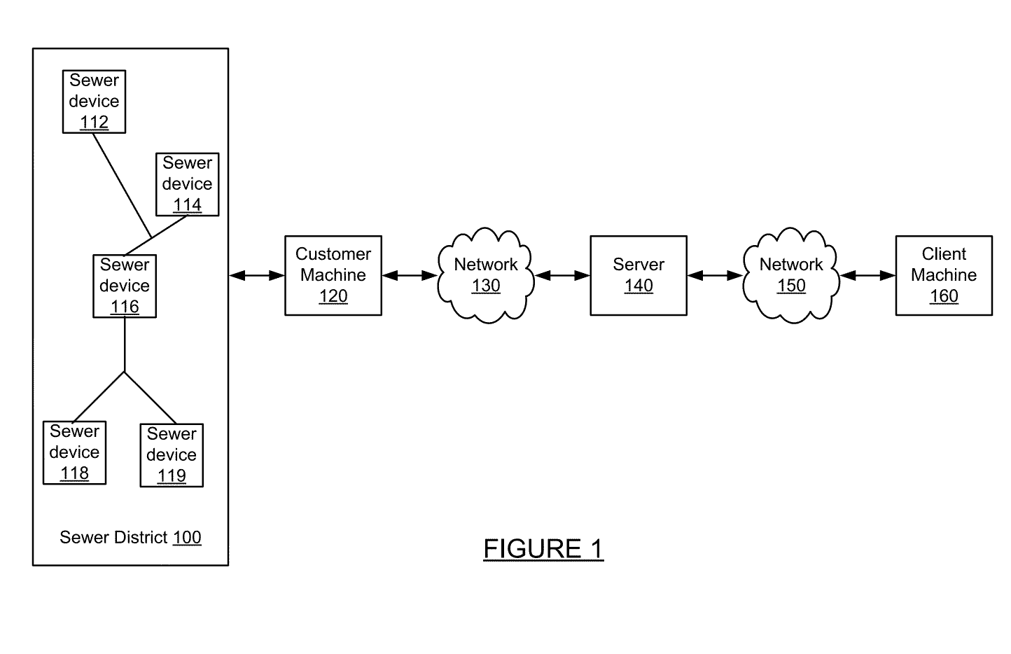

FIG. 1 is a block diagram of a system for providing collaborative water analytics. The system of FIG. 1 includes sewer District 100, customer machine 120, network 130, server 140, network 150, and client machine 160. Sewer district 100 may include one or more sewer devices 112, 114, 116, 118 and 119 arranged with flows of sewer and water between them. Each sewer device (“device”) may include a pump station to pump water, a sewage pit to collect sewage, a gauge for collecting rain, or some other device for measuring water or sewage flow. In some instances, each device, whether associated with water flow or sewage, may include one or more sensors to detect an aspect of the content being measured. The sensors may measure flow, volume, pressure, depth, velocity, or some other aspect of the content. Each device may also have multiple sensors which may communicate with customer machine 120. In some instances, each device may collect and transmit data to customer machine 120 periodically and/or on request. Data transmission may be through a wired line, a wireless system such as one or more antennas over a radio network, or some other means.

Customer machine 120 may include one or more machines for performing multiple tasks including receiving messages, transmitting messages, processing data, and storing data. In some instances, customer machine may include one or more application servers, network and web servers, data stores, and other servers and machines for receiving, processing, storing and transmitting data from devices 112-119 and other systems.

The data from each device by customer machine 120 may be received periodically, such as for example as a feed of time series data, and stored by customer machine 120. Data may be received by customer machine 120 from a device every minute, two minutes, five minutes, or at some other frequency. The data may be transferred through a supervisory control and data acquisition system (SCADA) or other suitable communications and control system. When using a SCADA system, the system may be utilized for remote monitoring and control using coded signals over communication channels between the sensors and the customer machines. In some instances, customer machine 120 may store the data in a data store or “historian” section of the customer machine such that the data can be accessed by remote servers.

Server 140 may implement a collaborative water analytics system as described herein and may include one or more network servers, application servers, data stores, and other servers and/or machines. Server 140 may access time series data associated with devices 112-119 over network 130 from customer machine 120. Network 130 may include a private network, public network, wired network, cellular network, wireless network, Wi-Fi network, or some other network suitable for transmitting data between customer machine 120 and server 140.

In some instances, data may be transferred from customer machine 120 to server 140. In some instances, server 140 may actively pull data from customer machine 120. The data pull requests may be performed using an SQL query that occurs periodically, initiated by user request, or based on some other event. The data retrieved from customer machine 120 may be stored at server 140 or some location accessible to server 140 in a format suitable for storing, accessing, and modifying large volumes of data. For example, data retrieved from machine 120 and stored on server 140 may be stored in a hierarchical data format such as HDF5, which consists of a data model, library, and file formats which provides for flexible and efficient input and output capability, particularly well-suited for high volume and complex data. Server 140 may retrieve and store data such that the time series data for each feed is received and added to previous data associated with the feed, and the data is dynamically reformatted and normalized. Processing the data in HDF5 format allows the data to be processed in chunks that are easily accessible, providing efficient access a processing capability for large amounts of time series data.

Server 140 may process the received and stored time series data to dynamically provide intelligent information based on the time series data feed as well as the raw data itself. The information and data may be provided to a user through an interface, such as for example a content page provided in a web browser application by client machine 160. A web browser application on client machine 160 may provide a content page that provides collaborative water analytics information. Network 150 may include a private network, public network, wired network, cellular network, wireless network, Wi-Fi network, or some other network suitable for transmitting data between server 140 and client machine 160. The interface may also be provided through a client application, a mobile application, or some other program executing on a device that has a display or other output mechanism.

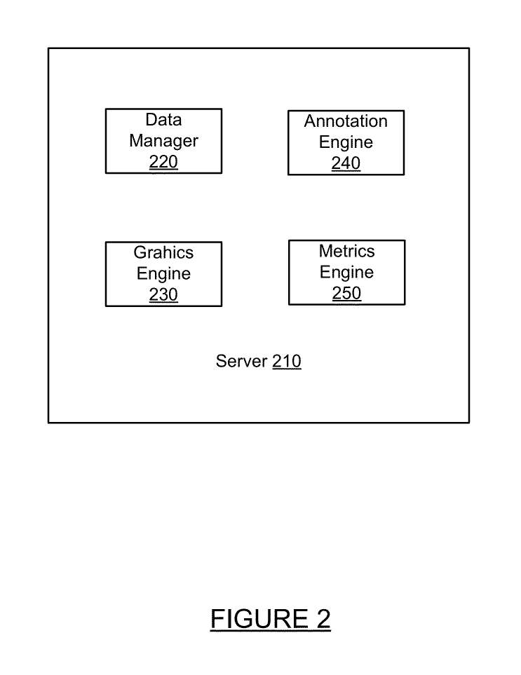

FIG. 2 illustrates a block diagram of an application server. The application server of FIG. 2 provides more detail of an application server that may comprise at least a portion of server 140 in the system of FIG. 1. Server 210 of FIG. 2 may include data manager 220, graphics engine 230, annotation engine 240 and metrics engine 250. In some instances, one or more of the modules 220, 230, 240 and 250, as well as other functionality discussed herein, may be stored and executed on client machine 160. For example, graphics engine 230 and annotation engine 240 may be implemented in script code within a network browser application on client machine 160. Additionally, some functionality provided by modules 220-250 as well as other functionality herein may be provided in both server 140 and client 160.

Data manager 220 may access and/or query data from customer machine 120, store the data, and provide data to modules 230-250 as required. Data manager 220 may generate and transmit SQL queries, upload data to a database accessible by server 210, and export data.

Graphics engine 230 may construct content pages that include an interface for viewing collaborative analytics information, metrics, graphs, tools, and other content and provide the content page to a web browser application hosted on client machine 160. Annotation engine 240 may handle generating annotations for a selected period of time series data and provide the annotation information to graphics engine 230. Metrics engine 250 may automatically and continuously generate metrics for time series data and provide the metrics to graphics engine 230. In some instances, metrics engine 250 may generate metrics on demand when metric information is requested or for automatic inclusion in a content page provided by graphics engine 230.

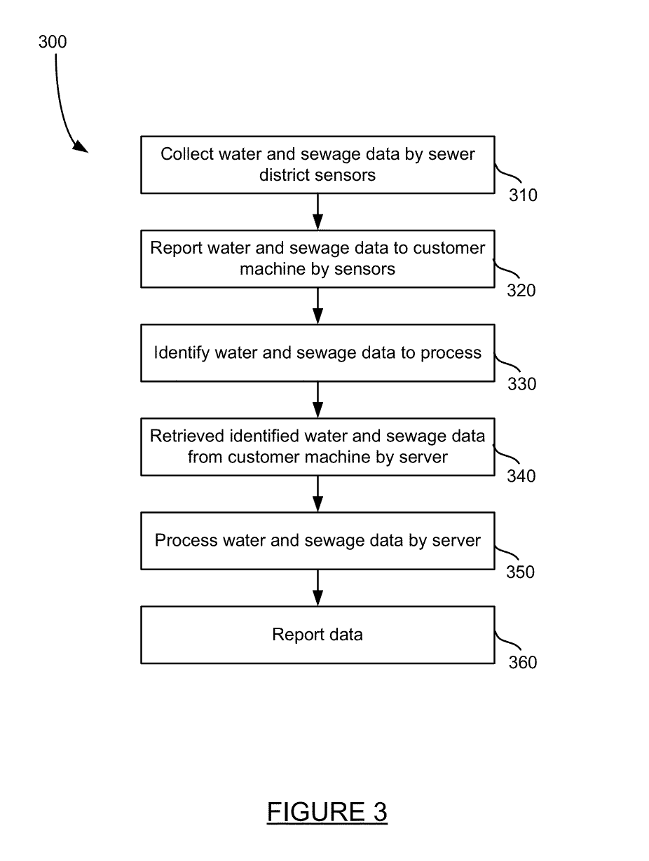

FIG. 3 is a method for providing collaborative water analytics. First, water and sewage data is collected by sewer district sensors at step 310. The water and sewage data may be collected by one or more sensors at each of devices 112-119. The water and sewage data may then be reported to customer machine 120 at step 320. The collected data may be reported to customer machine 120 by a wireless means such as radio frequency transmission devices, wired communication lines, or some other communication mechanism. Water and sewage data may be identified for processing at step 330. The identified water and sewage data will be accessed by server 140 and processed for reporting to a user via client machine 160. In some instances, an administrator associated with customer machine 120 may identify water and sewage data to be identified for processing. The identified data may include all collected data or a subset of all data, such as for example a subset of the data feeds or sensors used in sewer district 110. In some instances, logic or one or more business rules or algorithms may identify water data and sewer data to be analyzed, such as data associated with an anomaly, data associated particular periods of time, or other data.

The identified water and sewage data is retrieved from customer machine 120 by server 140 at step 340. The data may be retrieved through the one or more SQL queries sent by server 140 to customer machine 120. Data may be retrieved from customer machine 120 by server 140 and stored at server 140 locally or at an accessible remote data store. In some instances, server 140 can mirror the identified data from machine 120 to server 140, and the mirrored data may then be queried locally from server 140.

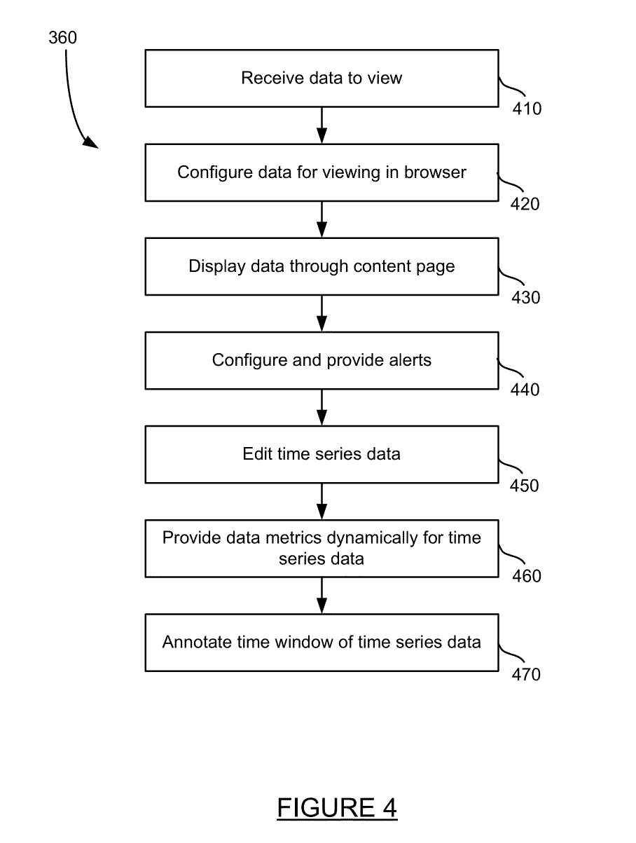

After retrieving the identified data, the water and sewage data retrieved by the server 140 may be processed at step 350. Processing the data may include storing it in a suitable format, such as in HDP5 format, processing the data to be displayed in a browser in an efficient manner, and other processing. Data may then be reported at step 360. The data may be reported graphically as a plot, table, graph, list annotation, metric, or in any other suitable format, and may be reported through a content page provided by a network browser application on client machine 160. Reporting data is discussed in more detail below with respect to the method of FIG. 4.

FIG. 4 is a method for reporting data. The method of FIG. 4 provides more detail for step 360 of the method of FIG. 3. First data to view may be received at step 410. The data may include data from one or more feeds, sewer districts, municipality systems, or some other collection of time series data. The data may be retrieved from local or remote memory or data stores.

The received data is then configured for viewing in a browser at step 420. Server 140 may configure the data to be viewed efficiently in a browser executing on a client machine 160. Configuring the data for efficient viewing may include manipulating the data to be displayed as accurately as possible in the limited visual range provided by a content page within a network browser application. For example, a time series may have hundreds of thousands of data points for a particular time series. A content page may only have a fraction of this number of pixels to display data. As such, the data needs to be manipulated to convey data values while minimizing data loss. The processing may include implementing a methodology for reducing the number of points in a curve or other portion of the data that is approximated by series of points. In some instances, a Douglas Peucker or similar iterative and point fit algorithm may be used to efficiently display large numbers of time series data within the granularity provided by a content page to be viewed through a web browser application. In some instances, configuration of the data for viewing may be performed at client 160. For example, script code such as JavaScript may execute in a network browser application to configure the data for viewing in a browser, including applying a version of all or part of an iterative and point fit algorithm such as the Douglas Peucker algorithm.

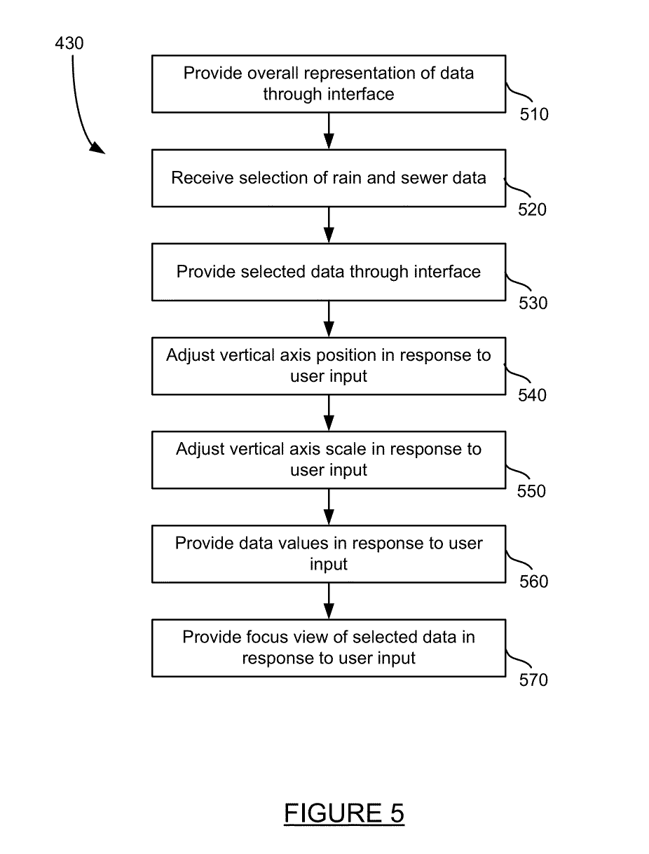

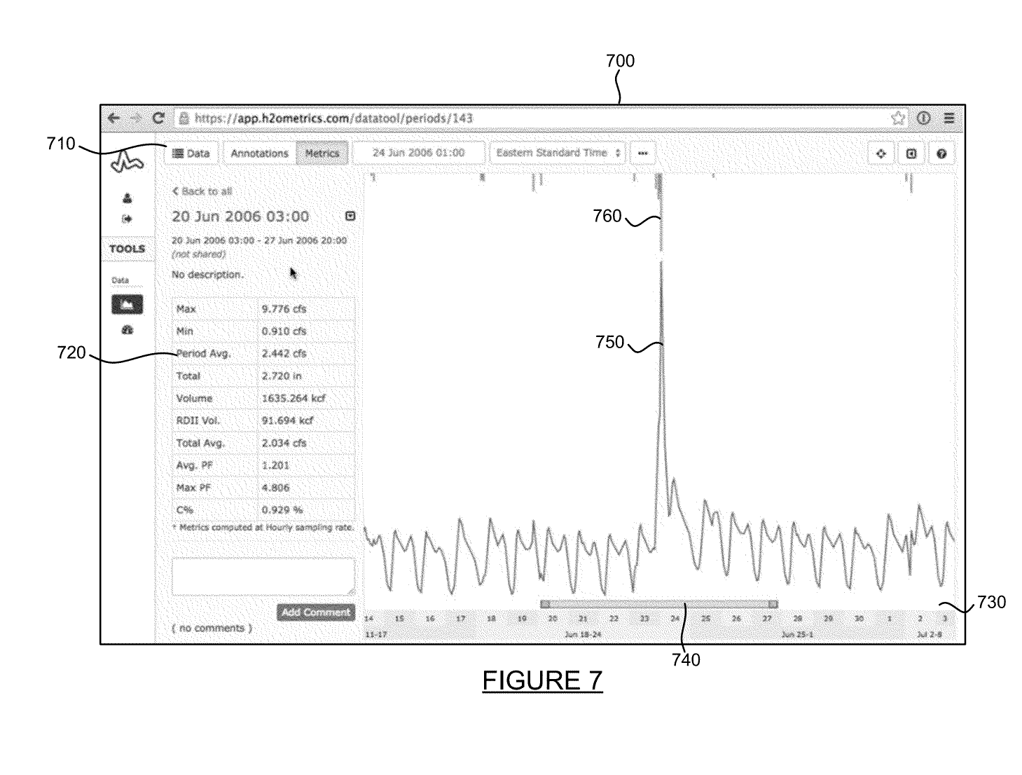

Once the data is configured for viewing in a browser, the set of time series data may be displayed through a content page at step 430. Displaying data through the content page is discussed in more detail below with respect to the method of FIG. 5. Snapshots of interfaces for displaying data are discussed with respect to FIGS. 7-10.

Alerts may be configured and provided at step 440. In some instances, an alert may be configured by a user to trigger an action based on a detected value, trend, or other logic or rule based on one or more data values in a time series data feed. For example, if the value of a particular feed of time series data exceeds a particular value, an alert may be sent to an administrator of server 140, customer machine 120, server district 100, or another party or address location with respect to the particular time feed. If, for example, a particular flow for rainfall data exceeds a maximum value, an alert may be generated to advise an administrator that a potential flood, system or sensor failures, water main breaks, or a sewer overflows situation may be forthcoming. Alerts may be generated based on a particular value, a trend, such as an increase seen over a particular period of time, or other properties for time series data.

Data may be edited at step 450. In some instances, a particular time series value or series of values may be identified as being anomalous. For example, a sensor may be identified as failing to perform for a particular period of time. As such, an administrator may wish that the data associated with the sensor be discarded, ignored, or otherwise not considered. Such data may be replaced using an edit feature of the current system. The edit feature may allow a user to insert data from a substitute device, perhaps scaled in some way to fit the new set of data, or generate data to be inserted from a more rigorous predictive modeling methodology. For example, if a particular sensor was determined to be malfunctioning for a period of time, the data associated with that sensor during that time may be discarded, and a pattern which is typically seen for that period of time may be generated and inserted in place of the discarded data. In some instances, the selected time period for the time series data to be replaced may be selected, an indication that the data should be replaced or edited is received, a user may indicate a particular pattern or estimation of time series behavior to insert in place of the selected data, and the system will then automatically generate data points corresponding to the time series periodicity to insert within the selected range.

Metrics for data may be provided dynamically for time series data at step 460. Metrics may be provided automatically for data currently being viewed by user or otherwise selected by a user. For example, the user interface may receive input from a user of a period of data. Upon receiving the selection, the selected period may be provided to server 140, and server 140 may determine the particular metrics. Server 140 may then update a content page through client machine 160. The updated content page may show the metrics associated with the particular time period. In some instances, metrics may automatically be generated and provided to a user for the most recent minute, 30 minutes, hour, 2 hours, 12 hours, 24 hours, week, month, or some other period of time that may be set by default or configured by a user. The automatically generated metrics may be updated dynamically as additional time series data for a particular feed for which the metrics are generated are received.

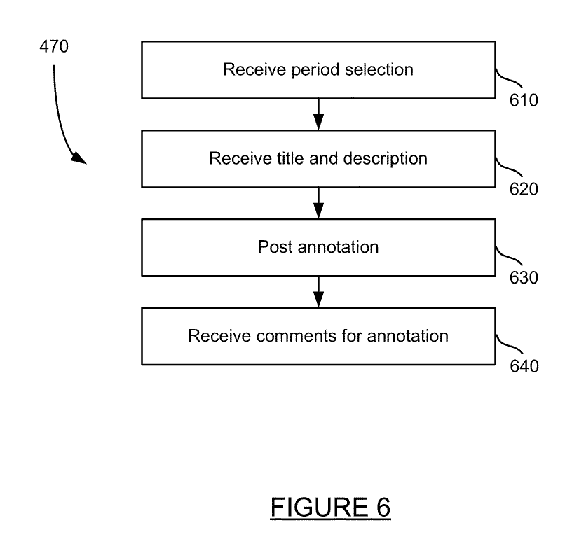

A time window of time series data may be annotated at step 470. Annotations may be generated not only for a particular time value, but also a period of time values. Thus, a particular trend or other subset of data may be annotated by a particular user. In addition to annotating the period of time series values, the annotations may be posted, commented on by other users, and shared. More details for annotating a period of data is discussed with reference to FIG. 6.

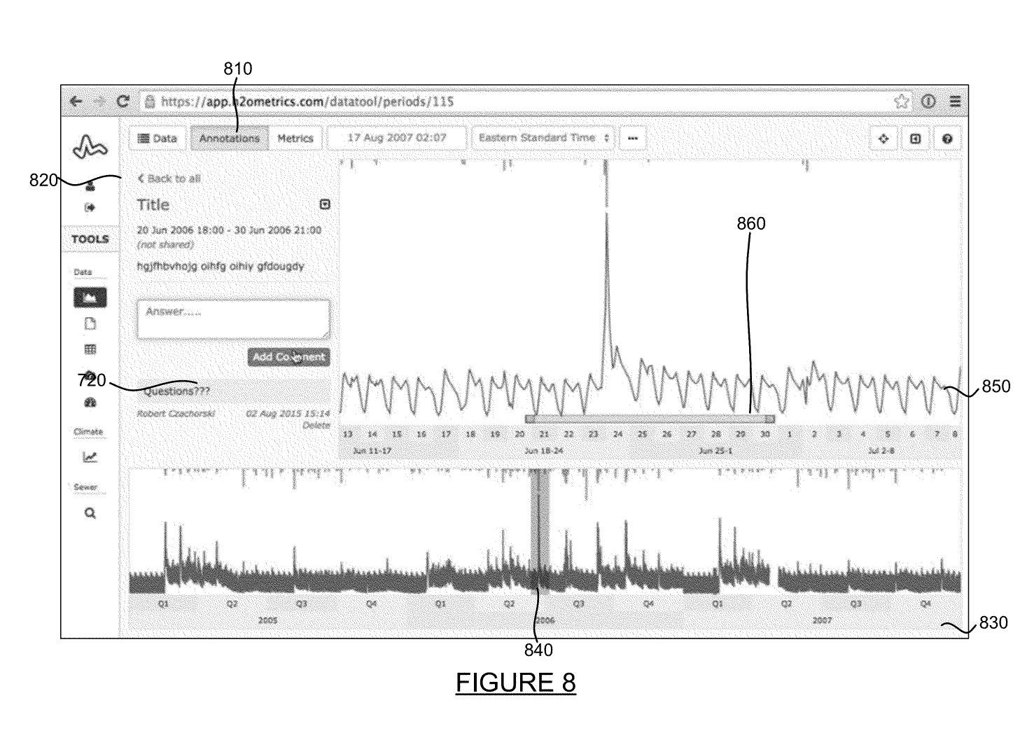

FIG. 5 illustrates a method for displaying data through a content page. The method of FIG. 5 provides more detail for step 430 of the method of FIG. 4. First, an overall representation of data is provided through an interface at step 510. The overall representation may be provided for an entire group of data associated with a particular feed. For example, in the interface of FIG. 8, the overall representation of data is provided in window 830 four 3 years of data, 2005-2007. A selection of rain and sewer data may be received at step 520. The selection may be received by receiving input from a content page of a subset of the overall representation of data. In the interface of FIG. 8, the receive selection is highlighted as selection 840 of the overall representation of data near the bottom of the interface.

The selected data is provided through the interface at step 530. The selected data will be illustrated such that more detail for the selected data may be visible then that which is visible for the overall representation of data provided at step 510. For example, window 850 provides the selected data through interface 800 of FIG. 8 which corresponds to the selected portion 840.

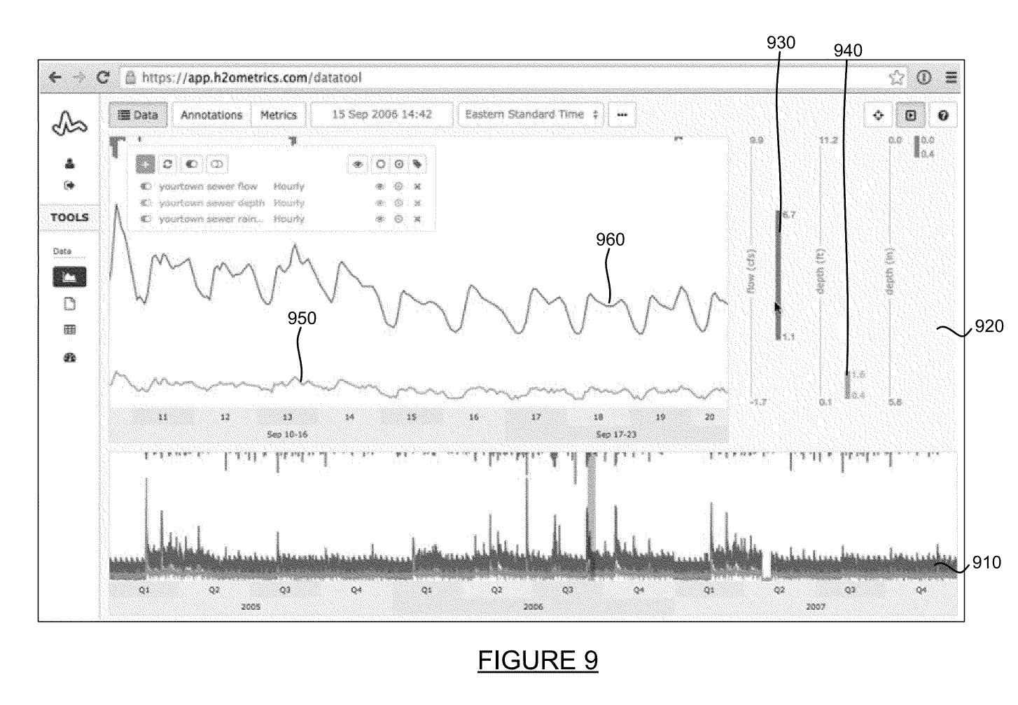

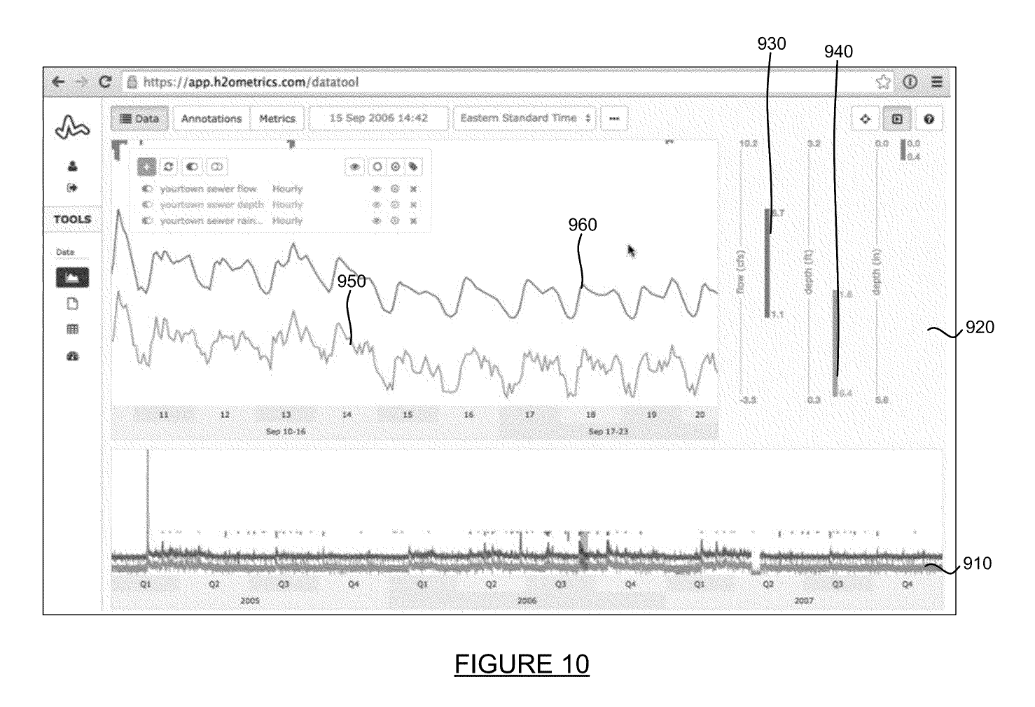

A vertical axis position may be adjusted in response to user input at step 540. The interfaces of FIGS. 9 and 10 illustrate vertical axes that are configured by a user. The vertical axes of FIG. 9 may be adjusted to move the axes direction either up or down within the interface. This may be achieved by selecting an axis indicator and moving the indicator in a vertical direction within the content page. By moving the vertical position of the axis, additional data may be provided in window 920 and the axes may be configured for more efficient viewing to more easily identify a pattern or relationship between multiple data feeds.

A vertical axis scale may be adjusted in response to receiving user input at step 550. To adjust the vertical axis scale, the user may adjust the vertical length of an indicator 930 or 940 in the interface of FIG. 10. For example, data associated with a sewer depth is represented by plot 950 within the interface of FIG. 9. As shown in FIG. 9, the axis indicator 940 is smaller than the axis indicator 930. In the interface of FIG. 10, axis indicator 940 is extended to be nearly as long as access indicator 930 associated with plot 960. As a result, plot 950 extends vertically within window 920 to a height that extends from the top of access indicator 940 to the bottom of access indicator 940, thereby increasing the scale of the plotted data in the interface of FIG. 10. By adjusting the scale of one or more vertical axis independently, the interface of the present system allows a user to more accurately determine relationships between feeds of data that would not normally be viewable and other systems with a fixed scale. This provides a distinct advantage for determining cause-and-effect relationships between components of water systems that is not available in other monitoring and reporting systems.

Data values are provided in response to user input at step 560. In some instances, user may select a portion of a particular feed through a user interface. In response to receiving the selected portion, data values for the particular portion may be provided in the interface. Further, as a user's moves an indicator horizontally or otherwise along a plot of data associate with a particular feed, the values for the particular feed are shown at the point of the cursor as it is dragged along the data feed plot.

A focus view of selected data is provided in response to user input at step 570. The focus view may provide a close up of the data values for the particular feed as well as any other related feed. The focus view is provided in response to user input of a particular point in a particular feed.

FIG. 6 illustrates a method for annotating data. The method of FIG. 6 provides more detail for step 470 the method of FIG. 4. First, a selection of a period of data is received at step 610. The selection may be received through an interface provided through a content page, such as for example an interface similar to one of those illustrated in FIGS. 7-10. In the interface of FIG. 8, the period of data is selected as selection 840 within window 830. A title and description may be received for the annotation at step 620. Within window 820, a user may enter a title for the annotation as well as a description for the annotation. The title and description may be entered as anything the user prefers. In some instances, a default title may be generated for example based on a name associated with the particular feed and time window, and a description may automatically be generated to provide more information regarding the type of data, time period of the data, and other information. An annotation may be posted at step 630. To post an annotation, an initial annotation, including text entered by a user, is received from the user. The annotation information is received through the content page, transmitted to server 140, and built into content pages associated with the feed that provides the subset of data values associated with the annotation. From that point forward, whenever the user or other users of view data for the particular feed, they will see an indicator that the particular period of data includes in annotation, or will see the annotation itself.

Comments for the generated annotation are received at step 640. Comments may be received from the user that created the annotation or other users that view the annotation. Comments received for the annotation will be associated with the subset of time series data originally associated with the annotation. Thus, both the original annotation and subsequent comments are associated with a set of multiple data points selected by a particular user, not with just a single point or data value. This is advantageous over other systems and that it allows users to comment on a trend of the data, an anomaly in context of other data, as well as other aspects of a set of multiple data points in a time series feed of data. The annotation for the set of time series data is stored and continuously updated with user comments in a data store accessible by server 140.

FIG. 7 is a snapshot of an interface for providing metrics. Interface 700 of FIG. 7 includes control buttons 710, metrics 720, access label 730, slider 740, sewer data plot 750, and rain data plot 760. The control buttons include selectable buttons provided within the interface and relate to data, annotations, and metrics. Other buttons indicate the current time and time zone for the data being displayed in the interface. In interface 700, the metrics button is currently selected. As such, metrics for the currently selected period are displayed in metrics window 720. The metrics may include a maximum and minimum flow, average flow for the period, total flow, a volume of flow, total average, and other metrics. The metrics may be provided by default, selected by user, or even created by user. As a user adjusts slider 740, metrics are generated for data corresponding to the currently selected period as defined by the slider. Thus, as slider 740 is moved to the left, the metrics will be generated for data corresponding to the boundaries of the slider as it is moved to the left.

FIG. 8 is a snapshot of an interface for providing annotations. As discussed with respect to the method of FIG. 6, annotations may be associated with a particular subset or period of time series data values. Once the annotations button is selected, a period of an overall data within data window 830 is selected. In the interface of FIG. 8, the selected data is indicated by selection 840. The selected data is then shown in more detail in window 850, positioned above data window 830 in the interface of FIG. 8. Slider 860 may be moved vertically along the selected data, as well as be adjusted for width, to be wider or shorter. Once the slider represents the period of data values to annotate, a user may enter a title, description, and one or more comments as annotations to associate with the selected subset of data. The annotation may then be posted, which makes the annotation available for others to comment on as well. Posting an annotation may be done to the general public or to selected users.

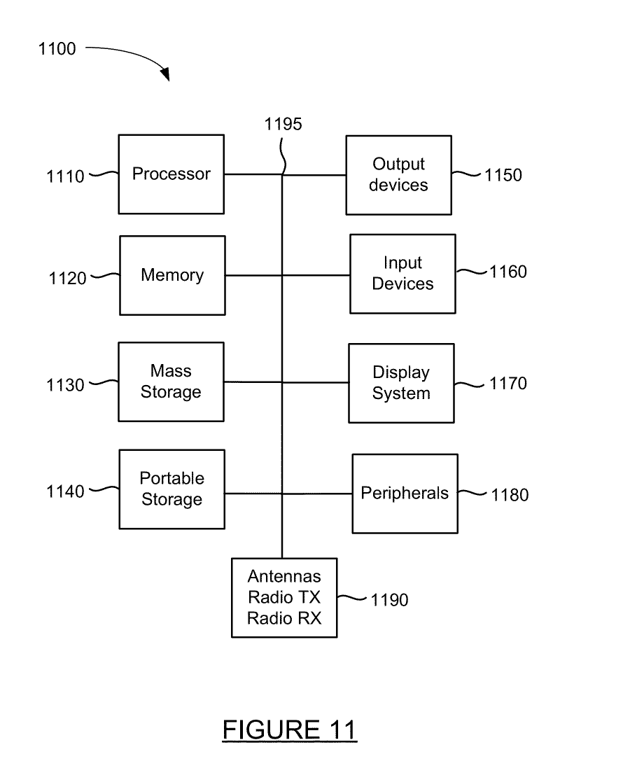

FIG. 11 illustrates a block diagram of a computing environment 1100 for implementing computers and machines that implement the present technology. System 1100 of FIG. 11 may be implemented in the contexts of the likes of customer machine (s) 120, server 140, and client machine 160. The computing system 1100 of FIG. 11 includes one or more processors 1110 and memory 1120. Main memory 1120 stores, in part, instructions and data for execution by processor 1110. Main memory 1120 can store the executable code when in operation. The system 1100 of FIG. 11 further includes a mass storage device 1130, portable storage medium drive(s) 1140, output devices 1150, user input devices 1160, a graphics display 1170, and peripheral devices 1180.

The components shown in FIG. 11 are depicted as being connected via a single bus 1190. However, the components may be connected through one or more data transport means. For example, processor unit 1110 and main memory 1120 may be connected via a local microprocessor bus, and the mass storage device 1130, peripheral device(s) 1180, portable storage device 1140, and display system 1170 may be connected via one or more input/output (I/O) buses.

Mass storage device 1130, which may be implemented with a magnetic disk drive, an optical disk drive, a flash drive, or other device, is a non-volatile storage device for storing data and instructions for use by processor unit 1110. Mass storage device 1130 can store the system software for implementing embodiments of the present invention for purposes of loading that software into main memory 1120.

Portable storage device 1140 operates in conjunction with a portable non-volatile storage medium, such as a floppy disk, compact disk or Digital video disc, USB drive, memory card or stick, or other portable or removable memory, to input and output data and code to and from the computer system 1100 of FIG. 11. The system software for implementing embodiments of the present invention may be stored on such a portable medium and input to the computer system 1100 via the portable storage device 1140.

Input devices 1160 provide a portion of a user interface. Input devices 1160 may include an alpha-numeric keypad, such as a keyboard, for inputting alpha-numeric and other information, a pointing device such as a mouse, a trackball, stylus, cursor direction keys, microphone, touch-screen, accelerometer, and other input devices Additionally, the system 1100 as shown in FIG. 11 includes output devices 1150. Examples of suitable output devices include speakers, printers, network interfaces, and monitors.

Display system 1170 may include a liquid crystal display (LCD) or other suitable display device. Display system 1170 receives textual and graphical information, and processes the information for output to the display device. Display system 1170 may also receive input as a touch-screen.

Peripherals 1180 may include any type of computer support device to add additional functionality to the computer system. For example, peripheral device(s) 1180 may include a modem or a router, printer, and other device.

The system of 1100 may also include, in some implementations, antennas, radio transmitters and radio receivers 1190. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth devices, and other radio frequency networks. The devices may include one or more radio transmitters and receivers for processing signals sent and received using the antennas.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, hand held computing device, smart phone, mobile computing device, workstation, server, minicomputer, mainframe computer, or any other computing device. The computer can also include different bus configurations, networked platforms, multi-processor platforms, etc. Various operating systems such as Unix, Linux, Windows, iOS, and Android and programming languages including, C, C++, Node.JS, and .NET can be used in one or more of the computer, servers, and/or machines discussed herein.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for analyzing data for time-series data retrieved from a water sensor system, comprising:
retrieving by a remote server time series data collected from a water system;
processing the time series data to be displayed within a content page by a network browser application provided by a client machine remote from the server;
providing a subset of the processed time series data in multiple graphical representations within the content page; and
modifying the scale of one or more of the multiple graphical representations in response to user input.

2. The method of claim 1, further comprising storing the time series data by the remote server in HDF5 format.

3. The method of claim 1, wherein processing the time series data to be displayed includes applying an iterative and point fit algorithm to the time series data.

4. The method of claim 1, wherein the multiple graphical representations include multiple plots of data.

5. The method of claim 1, further comprising:
providing an axis indicator for each of a plurality of vertical axes in the graphical representation; and
receiving an input to adjust a length of one of the plurliaty of axis indicators; and
adjusting the scale of an axis that corresponds to the axis indicator with the adjusted length.

6. The method of claim 5, wherein the axis scale is adjusted in proportion to the adjusted length of the axis indicator.

7. The method of claim 1, further comprising providing an annotation for a set of multiple time series data values.

8. The method of claim 1, wherein the annotation is associated with a set of multiple time series data values that are selected by a user.

9. The method of claim 1, further comprising automatically and dynamically generating metrics for a selected feed of time series data.

10. A non-transitory computer readable storage medium having embodied thereon a program, the program being executable by a processor to perform a method for analyzing data for time-series data retrieved from a water sensor system, the method comprising:
retrieving by a remote server time series data collected from a water system;
processing the time series data to be displayed within a content page by a network browser application provided by a client machine remote from the server;
providing a subset of the processed time series data in multiple graphical representations within the content page; and
modifying the scale of one or more of the multiple graphical representations in response to user input.

11. The non-transitory computer readable storage medium of claim 10, further comprising storing the time series data by the remote server in HDF5 format.

12. The non-transitory computer readable storage medium of claim 10, wherein processing the time series data to be displayed includes applying an iterative and point fit algorithm to the time series data.

13. The non-transitory computer readable storage medium of claim 10, wherein the multiple graphical representations include multiple plots of data.

14. The non-transitory computer readable storage medium of claim 10, further comprising:
providing an axis indicator for each of a plurality of vertical axes in the graphical representation; and
receiving an input to adjust a length of one of the plurliaty of axis indicators; and
adjusting the scale of an axis that corresponds to the axis indicator with the adjusted length.

15. The non-transitory computer readable storage medium of claim 14, wherein the axis scale is adjusted in proportion to the adjusted length of the axis indicator.

16. The non-transitory computer readable storage medium of claim 10, further comprising providing an annotation for a set of multiple time series data values.

17. The non-transitory computer readable storage medium of claim 10, wherein the annotation is associated with a set of multiple time series data values that are selected by a user.

18. The non-transitory computer readable storage medium of claim 10, further comprising automatically and dynamically generating metrics for a selected feed of time series data.

19. A system for analyzing data for time-series data retrieved from a water sensor system, comprising:
a server including a memory and a processor; and
one or more modules stored in the memory and executed by the processor to retrieve by a remote server time series data collected from a water system, process the time series data to be displayed within a content page by a network browser application provided by a client machine remote from the server, provide a subset of the processed time series data in multiple graphical representations within the content page, and modify the scale of one or more of the multiple graphical representations in response to user input.

20. The system of claim 19, the one or more modules further executable to store the time series data by the remote server in HDF5 format.

21. The system of claim 19, wherein processing the time series data to be displayed includes applying an iterative and point fit algorithm to the time series data.

22. The system of claim 19, wherein the multiple graphical representations include multiple plots of data.

23. The system of claim 19, the one or more modules further executable to provide an axis indicator for each of a plurality of vertical axes in the graphical representation, receive an input to adjust a length of one of the plurality of axis indicators, and adjust the scale of an axis that corresponds to the axis indicator with the adjusted length.

24. The system of claim 23, wherein the axis scale is adjusted in proportion to the adjusted length of the axis indicator.

25. The system of claim 19, the one or more modules further executable to provide an annotation for a set of multiple time series data values.

26. The system of claim 19, wherein the annotation is associated with a set of multiple time series data values that are selected by a user.

27. The system of claim 19, the one or more modules further executable to automatically and dynamically generate metrics for a selected feed of time series data.
